(19) United States
(12) Patent Application Publication
(10) Pub. No.: US 2024/0246371 A1
(43) Pub. Date: Jul. 25, 2024

(54) MAGNETIC TIRE PROTECTION SYSTEM

(71) Applicant: Paul Klein, Hallandale, FL (US)

(72) Inventor: Paul Klein, Hallandale, FL (US)

(21) Appl. No.: 18/098,964

(22) Filed: Jan. 19, 2023

(51) Int. Cl. B60C 19/00; B60B 21/12; H01F 7/20

(52) U.S. Cl. CPC B60C 19/00; B60B 21/12; H01F 7/20; B60C 2019/005

(57) ABSTRACT

The present disclosure relates to a magnetic tire protection system incorporating one or a plurality of magnets arranged internally within a tire such that the magnetic field produced by each respective magnet repels magnetic objects within the road or operating environment away from the tire. The magnetic tire protection system may incorporate electromagnets with corresponding power sources to selectively produce the magnetic field produced by each respective electromagnet when it near a surface on which a tire is operating.

### TECHNICAL FIELD

The embodiments generally relate to the field of roadwheel tires.

### BACKGROUND

Various systems or devices for protecting vehicles tires exist; however, these passive systems and devices lack direct integration with tires or seek to repair punctured tires in a rapid manner rather than repel objects capable of potentially puncturing the tire.

### SUMMARY OF THE INVENTION

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

The present disclosure relates to a magnetic tire protection system constructed and arranged to actively repel objects capable of potential punctures in a tire.

The present disclosure relates to a magnetic tire protection system incorporating a plurality of magnets arranged internally within a tire such that the magnetic field associated with each respective magnet pushes magnetic objects within the road or operating environment away from the tire.

The present disclosure relates to a magnetic tire protection system incorporating a plurality of electromagnets in operative connection with a power source. The electromagnets may be arranged internally within a tire such that the magnetic field associated with each respective electro magnet pushes magnetic objects within the road or operating environment away from the tire. According to some embodiments, the system may selectively supply electric current to electromagnets nearest the road on which a vehicle travels in order to push magnetic objects within the road or operating environment away from the tire.

Both the foregoing general description and the following detailed description present embodiments intended to provide an overview or framework for understanding the nature and character of the embodiments disclosed herein. Any accompanying drawings are included to provide further understanding and are incorporated into and constitute a part of this specification. The drawings illustrate various embodiments of the disclosure, and together with the description explain the principles and operations thereof.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 depicts an illustrative version of a magnetic tire protection system as disclosed herein;

FIG. 2 depicts an illustrative version of a magnetic tire protection system as disclosed herein;

FIG. 3 depicts an illustrative version of a magnetic tire protection system as disclosed herein; and

FIG. 4 depicts an illustrative version of a magnetic tire protection system as disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described system or methods of use. Any specific details of the embodiments are used for demonstration purposes only and no unnecessary limitations or inferences are to be understood from there.

The specific details of single embodiments or variations described herein are to the described system and methods of use. Any specific details of the embodiments are used for demonstration purposes only and no unnecessary limitations or inferences are to be understood from there.

The present disclosure relates to a magnetic tire protection system constructed and arranged to repel magnetic objects from the tires of a vehicle such as, but not limited to, bicycles, pedestrian vehicles, commercial vehicles, heavy machinery, and the like. The disclosed magnetic tire protection system shall not be limited to traditional inflated rubber tires.

A magnetic tire protection system may include at least one magnet, or a plurality of magnets, disposed radially from the center point of a tire. The individual or plurality of magnets may produce magnetic field(s) arranged to repel magnetic objects from a tire during use or rotation. More specifically, the individual or plurality of magnets may produce magnetic field(s) arranged to repel magnetic objects from the tread of a tire to prevent puncture of the tire.

The individual or plurality of magnets may be electromagnets with corresponding power sources, such as batteries or external power sources in electronic communication with the individual or plurality of magnets. The individual or plurality of electromagnets may be selectively activated via the power sources by conducting electrical current to each of the individual or plurality of electromagnets simultaneously or at desired times or intervals. As a nonlimiting example, current may be conducted to the individual or plurality of electromagnets only when said individual or plurality of electromagnets are nearest the surface on which a tire is positioned or rotating. In this way, the individual or plurality of electromagnets may repel magnetic objects from the tire nearest the roadway or surface on which the tire is operating.

The individual or plurality of electromagnets may also include corresponding communication devices, such as wireless low frequency radio wave communication devices, configured to communicate with any number of onboard vehicle computing devices. The onboard computing devices may be configured to issue activation or deactivation commands to the power sources such that current is selectively conducted to the individual or plurality of electromagnets nearest the surface on which a tire is positioned or rotating. In this way, the system for magnetic tire protection may repel magnetic objects near a tire where the tire is in contact with, or near contact with, the surface on which the tire is positioned or moving. This may also reduce magnetic interference with the rest of the vehicle by disabling the individual or plurality of electromagnets distanced from the surface on which the tire is positioned or moving but which may be near magnetic vehicle components or vehicle components sensitive to magnetic fields.

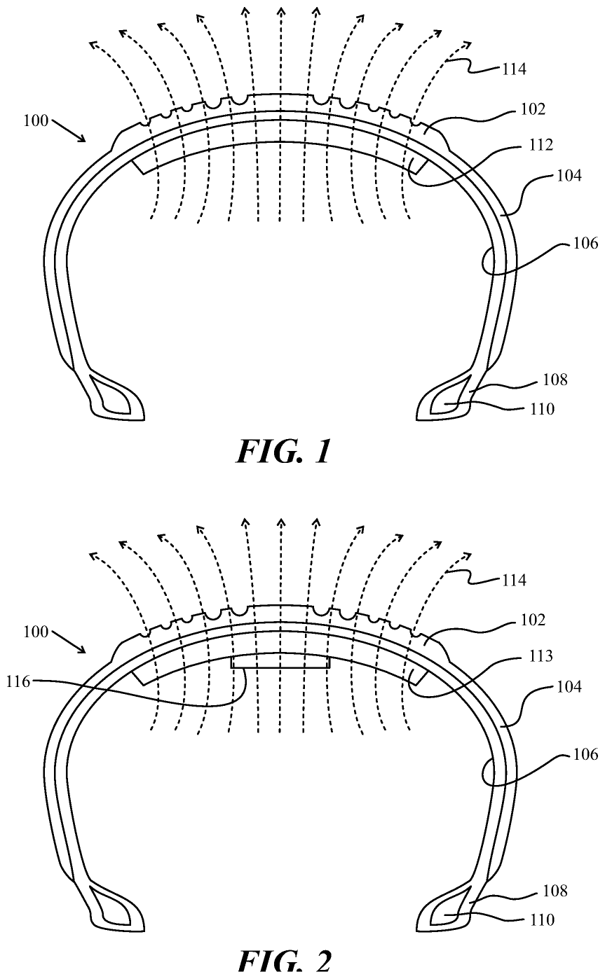

Referring to FIG. 1, an illustrative cross section of a tire is shown. A system for magnetic tire protection may be implemented within a tire 100, such as an inflatable rubber tire, the tire having a side wall 104 inner liner 106, flange 108, and node 110. The tire 100 may include a tread portion 102 constructed and arranged to facilitate traction between the tire 100 and a surface, such as a roadway. The system for magnetic tire protection may include at least one magnet 112 producing a magnetic field 114, the at least one magnet 114 being configured to repel magnetic objects from the tire 100 and more specifically the tire tread 102. The at least one magnet 112 may be a plurality of magnets disposed radially within the tire 100, against the liner 106, and generally mirroring the position of the tread 102.

Referring to FIG. 2, an illustrative cross section of a tire is shown. A system for magnetic tire protection may be implemented within a tire 100, such as an inflatable rubber tire, the tire having a side wall 104, inner liner 106, flange 108, and node 110. The tire 100 may include a tread portion 102 constructed and arranged to facilitate traction between the tire 100 and a surface. The system for magnetic tire protection may include at least one electromagnet 113 producing a magnetic field 114 constructed and arranged to repel magnetic objects from the tire 100 and, more specifically, the tire tread 102. The at least one electromagnet 113 may be a plurality of electromagnets disposed radially within the tire 100 against the liner 106 and generally mirroring the position of the tread 102. The system for magnetic tire protection may include an energy source 116, such as a battery, configured to deliver electrical current to the at least one electromagnet 113 such that the magnetic field 114 may be selectively produced during use by providing or not providing electrical current to any of the electromagnets in the plurality of electromagnets.

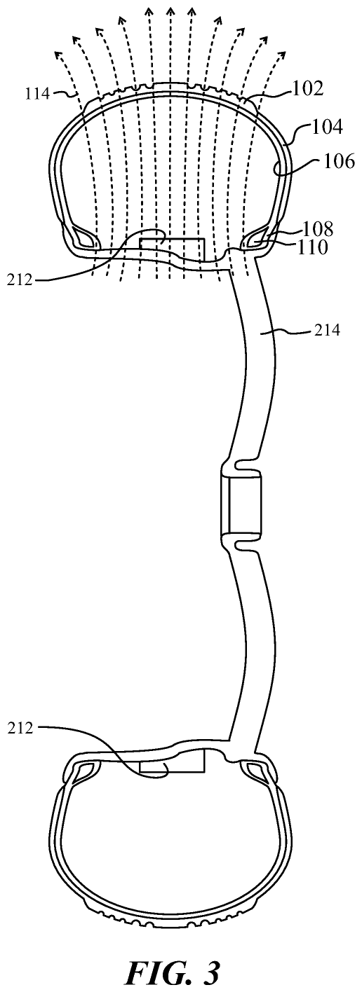

Referring to FIG. 3, an illustrative cross section of a wheel including a rubber tire and corresponding rim is shown. A system for magnetic tire protection may be implemented within a wheel, the wheel having a tire that may include a side wall 104, inner liner 106, bead flange 108, and node 110. The wheel may additionally include a rim 214 onto which the tire may be mounted. At least one magnet 212 may be disposed on a portion of the rim 214, and optionally disposed radially along the rim 214, to produce a magnetic field 114 such that magnetic objects are repelled from the wheel, including both the tire and the rim. It should be understood that while a simple magnet is depicted in FIG. 3, this disclosure contemplates that the magnet 212 may be a traditional magnet or electromagnet with corresponding power source constructed and arranged to provide current to the electromagnet such that the magnetic field 114 may be selectively enabled and disabled.

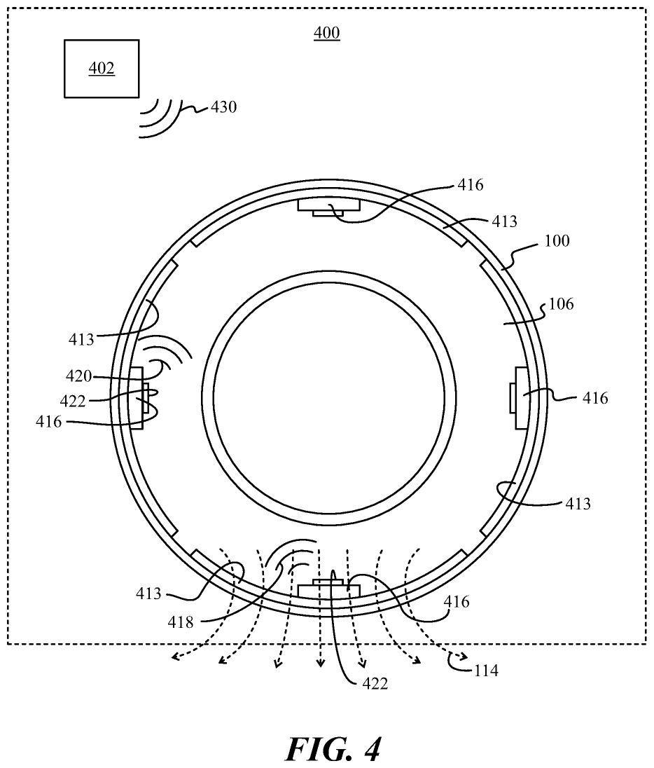

Referring to FIG. 4, an illustrative cross section of a wheel including a rubber tire is shown. A system for magnetic tire protection 400 may include a tire 100 and a plurality of electromagnets 413 disposed radially within the tire 100. Each electromagnet 413 may include a corresponding power source 416 constructed and arranged to provide current to the electromagnet 413 such that in magnetic field 414 may be generated to repel magnetic objects from the vicinity of the tire 100. Each of the plurality of electromagnets 413 and corresponding power sources 416 may include respective electronic communication devices 422 configured to communicate with a vehicle computer device 402 via wireless communication technology, such as, but not limited to, low frequency radio waves 420, 430.

In practice and in use, each of the individual assemblies of electromagnet, power source, and electronic communication device may be enabled and disabled, via instructions from the vehicle computing device 402, in-sync with the rotation of the tire, as measured by an onboard vehicle computing device 402, in order to repel magnetic objects nearest the portion of the tire in contact, or near in contact, with the surface below the tire.

The following description of variants is only illustrative of components, elements, acts, product, and methods considered to be within the scope of the invention and are not in any way intended to limit such scope by what is specifically disclosed or not expressly set forth. The components, elements, acts, product, and methods as described herein may be combined and rearranged other than as expressly described herein and still are considered to be within the scope of the invention.

According to variation 1, a system for magnetic tire protection may include at least one magnet disposed within a tire including tire tread, the at least one magnet being configured to produce a magnetic field to repel magnetic objects from the tire.

Variation 2 may include a system for magnetic tire protection as in variation 1, wherein the at least one magnet is a plurality of magnets disposed radially within the tire.

Variation 3 may include a system for magnetic tire protection as in variations 1 or 2, wherein the plurality of magnets is disposed radially within the tire approximately near the tire tread.

Variation 4 may include a system for magnetic tire protection as in any of variations 1 through 3, wherein the at least one magnet is at least one electromagnet.

Variation 5 may include a system for magnetic tire protection as in any of variations 1 through 4, wherein the at least one electromagnet includes a power source constructed and arranged to selectively enable the at least one electromagnet.

Variation 6 may include a system for magnetic tire protection as in any of variations 1 through 5, further including at least one electronic communication device in operable communication with the power source and the at least one electromagnet, wherein the at least one electronic communication device is configured to at least one of enable or disable the power source.

According to variation 7, a system for magnetic tire protection may include at least one magnet disposed within a wheel including a tire and a rim, the at least one magnet being configured to produce a magnetic field to repel magnetic objects from the tire.

Variation 8 may include a system for magnetic tire protection as in variation 7, wherein the at least one magnet is a plurality of magnets disposed radially on the rim.

Variation 9 may include a system for magnetic tire protection as in variation 7 or 8, wherein the at least one magnet is at least one electromagnet.

Variation 10 may include a system for magnetic tire protection as in any of variations 7 through 9, wherein the at least one electromagnet includes a power source constructed and arranged to selectively enable the at least one electromagnet.

Variation 11 may include a system for magnetic tire protection as in any of variations 7 through 10 further including at least one electronic communication device in operable communication with the power source and the at least one electromagnet, wherein the at least one electronic communication device is configured to at least one of enable or disable the power source.

According to variation 12, a system for magnetic tire protection may include a plurality of electromagnets disposed within a wheel including a tire and a rim; plurality of power sources correlating to each of the plurality of electromagnets, wherein the plurality of power sources is configured to deliver electric current to the plurality of electromagnets; and a plurality of electronic communication devices in operable communication with the plurality of electromagnets and the plurality of power sources, wherein the plurality of electronic communication devices is configured to at least one of enable or disable the plurality of power sources.

Variation 13 may include a system for magnetic tire protection as in variation 12, further including at least one computing device configured to wirelessly communicate with the Page 8 of 12 electronic communication devices to at least one of enable or disable the plurality of power sources.

Variation 14 may include a system for magnetic tire protection as in any of variations 12 through 13, wherein the at least one computing device is configured to wirelessly communicate via low frequency radio waves.

Variation 15 may include a system for magnetic tire protection as in any of variations 12 through 14, wherein the at least one computing device is configured to communicate with the electronic communication devices to at least one of enable or disable the plurality of power sources in-sync with rotation of the tire to repel magnetic objects near a portion of the tire in at least one of contact or near contact with a surface below the tire.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

1. A system for magnetic tire protection, comprising:
at least one magnet disposed within a tire comprising tire tread, the at least one magnet being configured to produce a magnetic field to repel magnetic objects from the tire.

2. A system for magnetic tire protection as in claim 1, wherein the at least one magnet is a plurality of magnets disposed radially within the tire.

3. A system for magnetic tire protection as in claim 2, wherein the plurality of magnets is disposed radially within the tire approximately near the tire tread.

4. A system for magnetic tire protection as in claim 1, wherein the at least one magnet is at least one electromagnet.

5. A system for magnetic tire protection as in claim 4, wherein the at least one electromagnet comprises a power source constructed and arranged to selectively enable the at least one electromagnet.

6. A system for magnetic tire protection as in claim 5, further comprising:
at least one electronic communication device in operable communication with the power source and the at least one electromagnet, wherein the at least one electronic communication device is configured to at least one of enable or disable the power source.

7. A system for magnetic tire protection, comprising:
at least one magnet disposed within a wheel comprising a tire and a rim, the at least one magnet being configured to produce a magnetic field to repel magnetic objects from the tire,
wherein the at least one magnet is at least one electromagnet comprising a power source configured to selectively enable the at least one electromagnet.

8. The system for magnetic tire protection as in claim 7, wherein the at least one magnet is a plurality of magnets disposed radially on the rim.

9. (canceled)

10. (canceled)

11. The system for magnetic tire protection as in claim 7, further comprising:
at least one electronic communication device in operable communication with the power source and the at least one electromagnet, wherein the at least one electronic communication device is configured to enable or disable the power source.

12. A system for magnetic tire protection, comprising:
a plurality of electromagnets disposed within a wheel comprising a tire and a rim,
a plurality of power sources correlating to each of the plurality of electromagnets, wherein the plurality of power sources is configured to deliver electric current to the plurality of electromagnets; and
a plurality of electronic communication devices in operable communication with the plurality of electromagnets and the plurality of power sources, wherein the plurality of electronic communication devices is configured to at least one of enable or disable the plurality of power sources and wherein the at least one computing device is configured to communicate with the electronic communication devices to enable or disable the plurality of power sources in-sync with rotation of the tire to repel magnetic objects near a portion of the tire in a point of contact or near the point of contact with a surface below the tire.

13. The system for magnetic tire protection as in claim 12, further comprising at least one computing device configured to wirelessly communicate with the electronic communication devices to at least one of enable or disable the plurality of power sources.

14. The system for magnetic tire protection as in claim 13, wherein the at least one computing device is configured to wirelessly communicate via low frequency radio waves.

15. (canceled)
